(19) United States
(12) Patent Application Publication
(10) Pub. No.: US 2025/0365042 A1
(43) Pub. Date: Nov. 27, 2025

(54) ELECTRONIC DEVICE AND METHOD OF OPERATING THE SAME

(71) Applicant: SAMSUNG ELECTRONICS CO., LTD., Suwon-si (KR)

(72) Inventors: Minki AHN, Suwon-si (KR); Sungsoo KIM, Suwon-s (KR); Jung Woon LEE, Suwon-si (KR)

(73) Assignee: SAMSUNG ELECTRONICS CO., LTD., Suwon-si (KR)

(21) Appl. No.: 19/098,470

(22) Filed: Apr. 2, 2025

(30) Foreign Application Priority Data
May 21, 2024 (KE) 10-2024-0066094

(51) Int. Cl. H04B 7/06

(52) U.S. Cl. CPC H04B 7/0602

(57) ABSTRACT

A method of operating an electronic device is provided. The method includes: controlling a switching circuit to control a first signal transmitted through a first antenna at a first time to be received via a second antenna; controlling the switching circuit to control a second signal transmitted via the second antenna at a second time to be received via the first antenna; and identifying an angle of arrival (AOA) of a target based on the first signal received via the second antenna and the second signal received via the first antenna.

### CROSS-REFERENCE TO RELATED APPLICATION(S)

This application claims the benefit of Korean Patent Application No. 10-2024-0066094, filed on May 21, 2024, in the Korean Intellectual Property Office, the disclosure of which is incorporated by reference herein in its entirety.

### BACKGROUND

### 1. Field

The present disclosure relates to an electronic device and a method of operating the same.

### 2. Description of Related Art

With the development of wireless communication technology, electronic devices are becoming commonly used. Recently, research and development has been conducted on radar as an example of an electronic device that utilizes wireless communication technology. When transmitting and receiving operations occur simultaneously by sharing an antenna, the quality of a received signal may deteriorate due to self-interference.

### SUMMARY

One or more example embodiments provide an electronic device that improves performance of measuring an angle of arrival (AOA) and controlling a switch to prevent self-interference from occurring, and a method of operating the electronic device.

Example embodiments are not limited to the technical aspects described above, and other goals may be provided by example embodiments.

According to an aspect of an example embodiment, a method of operating an electronic device, includes: controlling a switching circuit to control a first signal transmitted through a first antenna at a first time to be received via a second antenna; controlling the switching circuit to control a second signal transmitted via the second antenna at a second time to be received via the first antenna; and identifying an angle of arrival (AOA) of a target based on the first signal received via the second antenna and the second signal received via the first antenna.

According to another aspect of an example embodiment, an electronic device includes: a plurality of antennas including a first antenna and a second antenna; a switching circuit including a first switch, a second switch and a third switch; and a processor configured to: control the switching circuit to receive, via the second antenna, a first signal transmitted via the first antenna at a first time, control the switching circuit to receive, via the first antenna, a second signal transmitted via the second antenna at a second time, and identify an AOA of a target based on the first signal received via the second antenna and the second signal received via the first antenna.

According to another aspect of an example embodiment, an electronic device includes: a plurality of antennas including a first antenna and a second antenna; a switch circuit including a plurality of switches configured to control connection states of the plurality of antennas; and a processor configured to control the switch circuit to control the connection states at a first time to be different than the connection states at a second time, and identify an angle of arrival (AOA) of a target based on the signals received at the first time and the second time.

### BRIEF DESCRIPTION OF DRAWINGS

The above and other aspects and features will be more apparent from the following description of example embodiments, taken in conjunction with the accompanying drawings of which:

FIG. 1 is a flowchart for explaining a method of operating an electronic device according to an example embodiment;

FIG. 2 is a diagram for explaining the process of measuring an angle of arrival (AOA) based on the phase difference between signals received through different antennas according to an example embodiment;

FIGS. 3A, 3B, 3C and 3D are diagrams for explaining a process of controlling a switch so that a transmitting terminal and a receiving terminal do not share an antenna according to an example embodiment;

FIG. 4 is a diagram of a terminal including a plurality of antennas according to an example embodiment;

FIG. 5 is a diagram for explaining a process of measuring an AOA of a target through switch control according to an example embodiment;

FIG. 6 is a diagram illustrating a channel impulse response (CIR) according to an example embodiment;

FIG. 7 is a diagram for explaining results of evaluating AOA measurement performance according to an example embodiment;

FIG. 8 is a block diagram for explaining an electronic device according to an example embodiment; and

FIG. 9 is a block diagram for explaining a terminal according to an example embodiment.

### DETAILED DESCRIPTION

Terms used herein are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware.

Hereinafter, example embodiments will be described in detail with reference to the drawings. Like components are denoted by like reference numerals throughout the specification, and repeated descriptions thereof are omitted. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

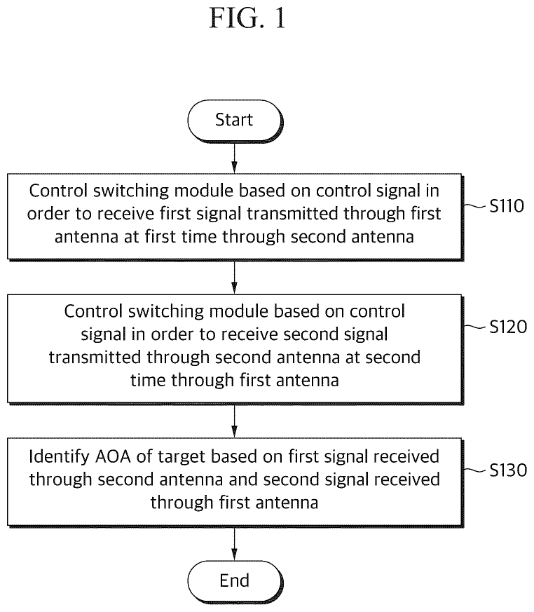

FIG. 1 is a flowchart for explaining a method of operating an electronic device according to an example embodiment.

Referring to FIG. 1, in operation S110, the electronic device may control a switching module (i.e., a switching circuit) based on a control signal in order for a first signal transmitted through a first antenna at a first time to be received through a second antenna.

Here, the switching module may include at least a first switch, a second switch and a third switch. The first switch is a switch that selectively connects a first antenna terminal corresponding to the first antenna and a first receiving terminal, and the second switch is a switch that selectively connects a second antenna terminal corresponding to the second antenna and a second receiving terminal, and the third switch is a switch that selectively connects either the first antenna terminal or the second antenna terminal to a transmitting terminal.

Here, at the first time, the on/off state of any one or any combination of the switches included in the switching module may be controlled based on the control signal that is generated in a processor. For example, at the first time, the switching module may be controlled based on a control signal that controls the first switch connecting the first receiving terminal and the first antenna terminal to be in the off state, the third switch to connect the transmitting terminal and the first antenna terminal and disconnect the transmitting terminal and the second antenna terminal, and the second switch connecting the second receiving terminal and the second antenna terminal to be in the on state. Therefore, self-interference may not occur because the transmitting terminal and the second receiving terminal do not share the first antenna but use antennas different from each other.

In operation S120, the electronic device may control the switching module based on the control signal in order to receive a second signal transmitted through the second antenna at the second time through the first antenna.

Here, at the second time, the on/off state of any one switch included in the switching module may be controlled based on a control signal that is generated in the processor. For example, the switching module may be controlled based on the control signal that controls the first switch connecting the first receiving terminal and first antenna terminal to be in the on state, the third switch to connect the transmitting terminal and the second antenna terminal and disconnect the transmitting terminal and the first antenna terminal, and the second switch connecting the second receiving terminal and the second antenna terminal to be in the off state, at the second time. Therefore, the self-interference may not occur because the transmitting terminal and the first receiving terminal do not share the second antenna but use different antennas.

In operation S130, the electronic device may identify an angle of arrival (AOA) of the target that is measured based on the first signal received through the second antenna and the second signal received through the first antenna.

Here, the electronic device may measure the AOA of the target based on a phase difference between the first signal received at the first time and the second signal received at the second time. Further, the electronic device may identify a location of the target based on the AOA of the target. In this regard, the electronic device may identify a location of the target by measuring the AOA of the target that moves periodically in a specific area. For example, based on the AOA, the electronic device may measure periodic and minutely moving signals (for example, the breathing rate and the heart rate) among human vital signals.

According to an example embodiment, when the target moves, the electronic device may control the number of packets transmitted and received in response to a fast Fourier transform (FFT) size determined based on the moving cycle of the target. Specifically, the electronic device may control the number of first and second signals transmitted and received in response to the FFT size. In an example embodiment, based on a lot of packets transmitted and received corresponding to the FFT size, the AOA of the target may be identified by a common phase difference being applied to a plurality of first signals and a plurality of second signals. When there is no movement in the target, because there is no phase change, the AOA of the target may be measured based on the phase difference between two different signals (in this regard, the first signal received at the first time and the second signal received at the second time).

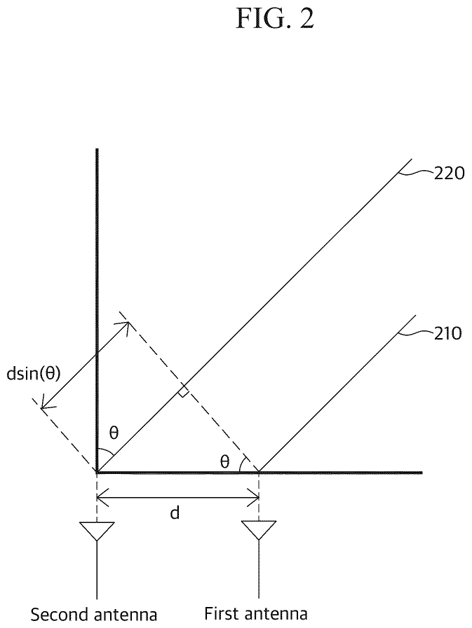

FIG. 2 is a diagram for explaining the process of measuring an AOA based on the phase difference between signals received through different antennas according to an example embodiment.

Referring to FIG. 2, each of the first antenna and the second antenna may transmit and receive signals, and the electronic device may identify the transmitted and received signals using each antenna. Here, the first antenna may receive a signal 210 arriving through a first path, and the second antenna may receive a signal 220 arriving through a second path. Here, the phase of the signal 210 received by the first antenna is ψ₁, and the phase of the signal 220 received by the second antenna is ψ₂.

The distance between the first antenna and the second antenna is d, which may be information known by the electronic device. For example, the distance d may be stored in the memory. The electronic device may identify the path difference dsin θ between the first path corresponding to the signal 210 and the second path corresponding to the signal 220. Here, based on the wavelength λ of the received signal, the phase difference between the phase ψ₁ of the signal 210 and the phase ψ₂ of the signal 220 may be determined according to Equation 1.

$$Δψ {=}^{Δ} {ψ}_{2} - {ψ}_{1} = \frac{2 π * d * sin θ}{λ} \qquad [ Equation 1 ]$$

Here, the electronic device may measure an AOA as shown in Equation 2 below based on Equation 1.

$$\hat{θ} = arc sin ( \frac{Δ ψ * λ}{2 π * d} ) \qquad [ Equation 2 ]$$

$$for - \frac{π}{2} < \hat{θ} < \frac{π}{2}$$

With reference to FIG. 2, receiving signals using two antennas is described, but the present disclosure is not limited thereto, and receiving signals using three or more antennas and measuring an AOA based on the signals may also be in the scope of the right of the present disclosure.

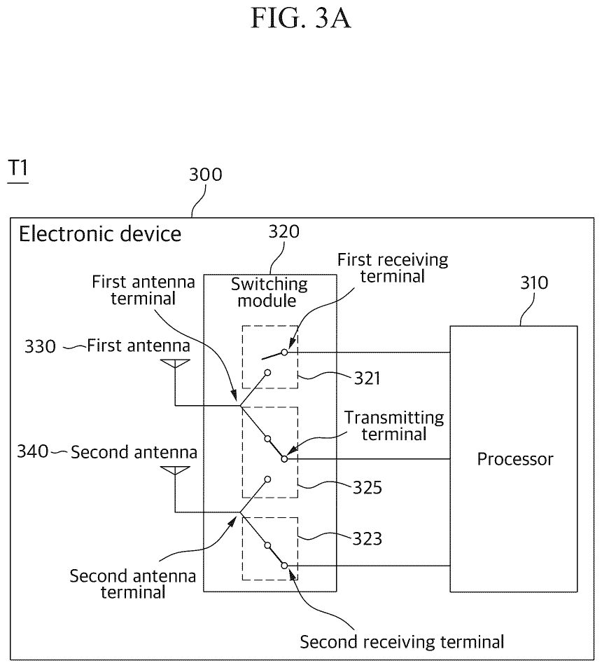

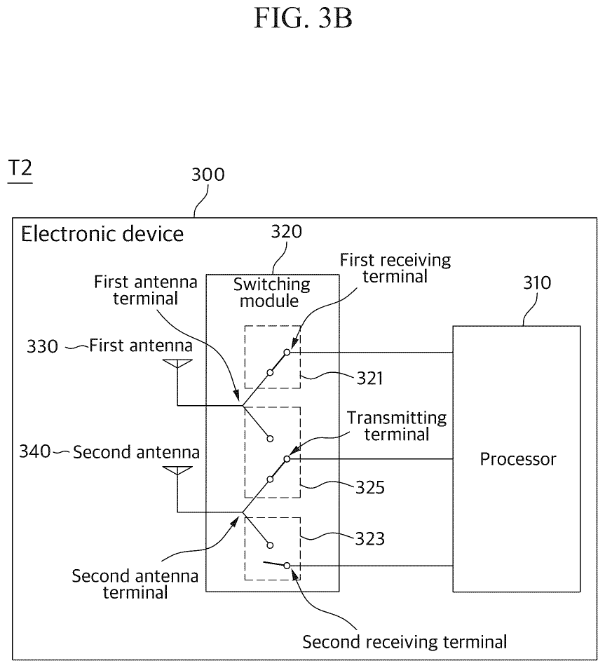

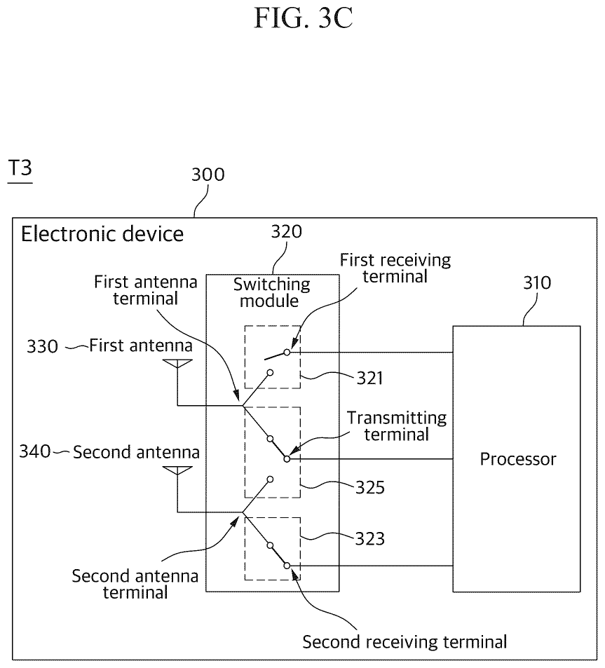

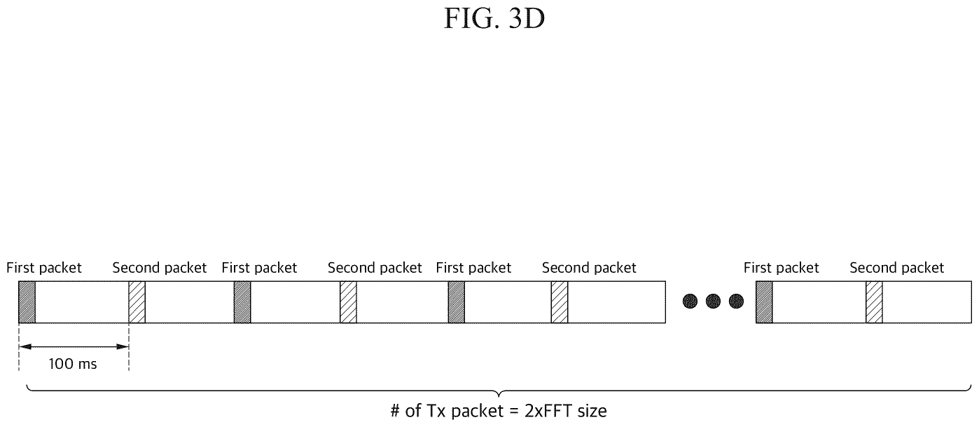

FIGS. 3A to 3D are diagrams for explaining a process of controlling a switch so that a transmitting terminal and a receiving terminal do not share an antenna according to an example embodiment.

Referring to FIGS. 3A to 3C, an electronic device 300 may include a processor 310, a switching module 320, a first antenna 330 and a second antenna 340. The switching module 320 may include a first switch 321, a second switch 323 and a third switch 325. Those skilled in the art would understand that other elements can be included in addition to the elements illustrated in FIGS. 3A to 3C.

Here, the signal generated by the processor 310 may be transmitted through either the first antenna 330 or the second antenna 340 connected through the transmitting terminal. Alternatively, the processor 310 may identify the signal received through the first antenna 330 through the first receiving terminal, and identify the signal received through the second antenna 340 through the second receiving terminal.

Specifically, the first antenna terminal corresponding to the first antenna 330 and the transmitting terminal are connected so that the signal generated by the processor 310 may be transmitted through the first antenna 330, and the second antenna terminal corresponding to the second antenna 340 and the second receiving terminal are connected, so that the processor 310 may identify the signal received from the second antenna 340.

Alternatively, the second antenna terminal corresponding to the second antenna 340 and the transmitting terminal are connected so that the signal generated by the processor 310 may be transmitted through the second antenna 340, and the first antenna terminal corresponding to the first antenna 330 and the first receiving terminal are connected, so that the processor 310 may identify the signal received from the first antenna 330.

For example, referring to FIG. 3A, at time T1, based on the control signal generated by the processor 310, the first switch 321 connecting the first receiving terminal and the first antenna terminal may be controlled to be in the off state, the third switch 325 may be controlled to connect the transmitting terminal and the first antenna terminal and disconnect the transmitting terminal and the second antenna terminal, and the second switch 323 connecting the second receiving terminal and the second antenna terminal may be controlled to be in the on state. In this regard, the first switch 321 and the third switch 325 may be controlled in order for the transmitting terminal and the first receiving terminal not to share the first antenna 330. In this case, the transmitting terminal is connected to the first antenna terminal and the signal generated by the processor 310 at the time T1 may be transmitted through the first antenna 330, the second antenna 340 may receive a signal that is the transmitted signal after being reflected from the target, and the second receiving terminal and the second antenna terminal are connected so that the processor 310 may identify the signal received by the second antenna 340. Unlike FIG. 3A in which the first switch 321 is controlled to be in the off state at the time T1, if the first switch 321 is controlled to be in the on state in order for the first receiving terminal and the first antenna 330 to be connected, the signal generated by the processor 310 may be transmitted through the first antenna 330 by the transmitting terminal and the first antenna terminal being connected, and unlike what is illustrated in FIG. 3A, the processor 310 may identify the signals received by the first antenna 330 and the second antenna 340, respectively. In this case, unlike the second receiving terminal, the first receiving terminal shares the first antenna 330 with the transmitting terminal and thus self-interference occurs. Accordingly, the quality of the signal that the processor 310 identifies through the first receiving terminal may be lower than the quality of the signal that the processor 310 identifies through the second receiving terminal. In order to measure an AOA, two or more received signals are required. Thus, when the quality of the signal identified through the first receiving terminal is relatively degraded compared to the quality of the signal identified through the second receiving terminal, the accuracy of AOA measurement may deteriorate. Accordingly, as is described with reference to FIGS. 3A to 3C, the processor 310 may control the switches of the switching module 320 based on the control signal in order for the transmitting terminal and the first receiving terminal not to share the first antenna 330.

For example, referring to FIG. 3B, at time T2, based on the control signal generated from the processor 310, the first switch 321 connecting the first receiving terminal and the first antenna terminal may be controlled to be on, the third switch 325 may be controlled to connect the transmitting terminal and the second antenna terminal and disconnect the transmitting terminal and the first antenna terminal, and the second switch 323 connecting the second receiving terminal and the second antenna terminal may be controlled to be off. In this case, at the time T2, the signal generated from the processor 310 by the transmitting terminal and the second antenna terminal being connected may be transmitted via the second antenna 340, the first antenna 330 may receive a signal that is the transmitted signal after being reflected from the target, and because the first receiving terminal and the first antenna terminal are connected, the processor 310 may identify the signal received by the first antenna 330. In this regard, the processor 310 may control the switches of the switching module 320 based on the control signal in order for the transmitting terminal and the second receiving terminal not to share the second antenna 340.

For example, referring to FIG. 3C, at time T3, based on the control signal generated from the processor 310, the first switch 321 connecting the first receiving terminal and the first antenna terminal may be controlled to be in the off state, the third switch 325 may be controlled to connect the transmitting terminal and the first antenna terminal and disconnect the transmitting terminal and the second antenna terminal, and the second switch 323 connecting the second receiving terminal and the second antenna terminal may be controlled to be on. In this case, at the time T3, the signal generated from the processor 310 by the transmitting terminal and the first antenna terminal being connected may be transmitted via the first antenna 330, the second antenna 340 may receive a signal that is the transmitted signal after being reflected from the target, and the processor 310 may identify the signal received by the second antenna 340 because the second receiving terminal and the second antenna terminal are connected. In this regard, the processor 310 may control the switches of the switching module 320 based on the control signal in order for the transmitting terminal and the first receiving terminal not to share the first antenna 330.

In this regard, operations identical to the operations at the time T1 may be performed at the time T3. As such, at time T4, operations identical to the operations at the time T2 may be performed, and such operations may be repeated at time T5 and at time T6, until the time corresponding to twice the FFT size.

Referring to FIG. 3D, a first packet may be received through the second receiving terminal, after a certain period of time (for example, 100 ms), a second packet may be received through the first receiving terminal, after a certain period of time (for example, 100 ms), the first packet may be received through the second receiving terminal, and even after then, identical operations may be repeated for a time period twice the FFT size. However, when the processor 310 identifies the signal reflected from the target through two receiving terminals at regular intervals due to two packet transmissions as illustrated in FIGS. 3A to 3D, twice as many packets need to be transmitted as when the processor 310 simultaneously identifies the signal reflected from the target through two receiving terminals due to a single packet transmission.

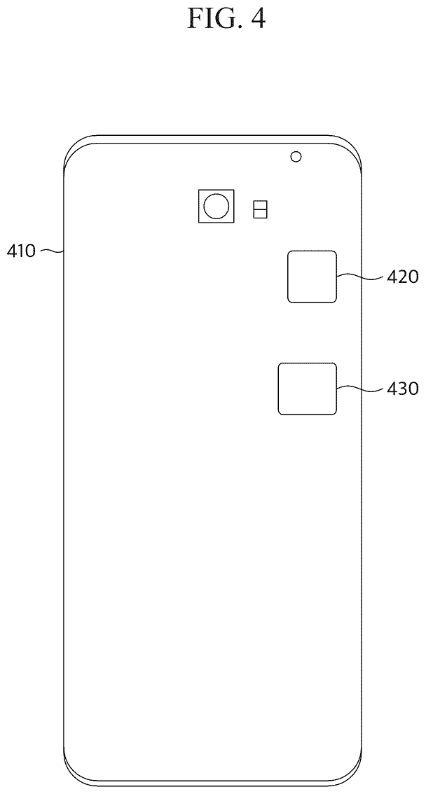

FIG. 4 is a diagram of a terminal including a plurality of antennas according to an example embodiment.

Referring to FIG. 4, a terminal 410 may include antennas 420 and 430. Here, the antennas 420 and 430 may be devices that support communication, and may be, for example, antennas that support ultra-wideband communication (UWB communication). The arrangement structure of the antennas 420 and 430 included in the terminal 410 illustrated in FIG. 4 is a provided as an example, and according to other example embodiments, antennas 420 and 430 may be placed in different planes. Alternatively, the antennas 420 and 430 may consist of different types of antennas. An antenna having an arrangement, number and type different from what is illustrated in FIG. 4 may be included in the scope of the right of the present disclosure.

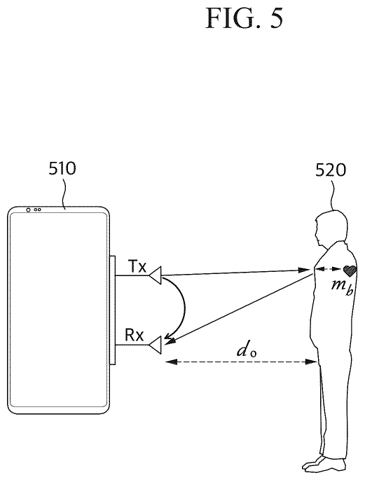

FIG. 5 is a diagram for explaining a process of measuring an AOA of a target through switch control according to an example embodiment.

According to an example embodiment, an electronic device 510 may identify a location of the target based on AOAs measured using different methods based on whether the target is moving or stationary. Specifically, the electronic device 510 may identify a location of the target based on AOAs measured for the target when the target moves at a specific frequency in a specific area. In this case, in order to detect the movement of the target, the electronic device 510 may measure the AOAs of the target through a process of transmitting and receiving a plurality of signals corresponding to the movement of the target, and based thereon, the electronic device 510 may identify a location of the target. For example, the electronic device 510 may detect subtle movements of chest of a person and measure the AOAs of the target, and based thereon, the electronic device 510 may identify a location of the target. Here, the electronic device 510 may measure signals that move periodically and minutely among human vital signals (for example, the heart rate and the respiration rate) based on AOAs of the target and identify a location of the target. If the target does not move, the electronic device 510 may measure the AOA of the target with only two different signals (i.e., a first signal and a second signal), unlike when the target is moving, and based thereon, the electronic device 510 may identify a location of the target.

Referring to FIG. 5, the electronic device 510 may transmit a signal to a target 520 and receive the signal reflected from the target. Specifically, the electronic device 510 may transmit a signal using an antenna connected to a transmitting terminal Tx, and may receive the signal reflected from the target 520 using an antenna connected to a receiving terminal Rx. Here, d₀ indicates the distance between the electronic device 510 and the target 520, m_{b} indicates the displacement according to the target movement, and f_{b} indicates the target frequency. For example, m_{b} may represent the displacement due to the movement of the rib cage during a person's breathing process, and f_{b} may represent the person's respiratory rate.

According to an example embodiment, when the contents described with reference to FIG. 2 are applied to the process of measuring human vital signs (for example, the respiration rate and the heart rate), the signal r₁(τ, t) received from the first antenna and the signal r₂(τ, t) received from the second antenna may be expressed as shown in the following Equation 3.

$${r}_{1} ( τ , t ) = p ( τ ) + ρ {e}^{j φ ( t )} * p ( τ - {τ}_{b} ) + n ( τ , t ) \qquad [ Equation 3 ]$$

$${r}_{2} ( τ , t ) = p ( τ ) + ρ {e}^{j φ ( t )} * {e}^{j Δ ψ} * p ( τ - {τ}_{b} ) + n ( τ , t )$$

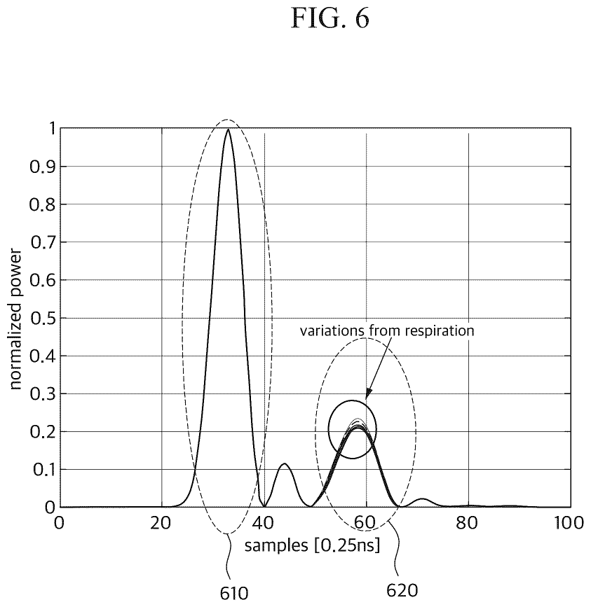

Here, p(τ) corresponds to a signal transmitted through an antenna connected to a transmitting terminal and directly received through an antenna connected to a receiving terminal. ρe^{jφ(t)}*p(τ−τ_{b}) corresponds to the signal transmitted through the antenna connected to the transmitting terminal, reflected from the target through the antenna connected to the transmitting terminal, after τ_{b}(in this regard, 2d₀/c). FIG. 6 is a diagram illustrating channel impulse responses (CIRs) measured a certain number of times (for example, 10 times) according to an example embodiment. In FIG. 6, a graph 610 is a CIR corresponding to p(τ), and a graph 620 is a CIR corresponding to p(τ−τ_{b}). The graph 620 shows a slight difference during 10 measurements due to the slight movement of the target.

Further, in Equation 3, ρe^{jφ(t)}*e^{jΔψ}*p(τ−τ_{b}) may correspond to the signal reflected from the target and received by the antenna. n(τ, t) may correspond to noise. Further, ρ may correspond to the amplitude of the signal reflected from the target and received, φ(t) is

$$φ ( t ) = \frac{2 π}{λ} {m}_{b} sin ( 2 π {f}_{b} t )$$

and may correspond to the phase according to the target's movement change, and Δψ may correspond to the phase difference.

According to an example embodiment, when the contents described in reference to FIGS. 3A to 3D are applied to Equation 3, the signal r₁(τ, t) received by the first antenna and the signal r₂(τ, t+Δt) received by the second antenna may be expressed as Equation 4 below.

$${r}_{1} ( τ , t ) = p ( τ ) + ρ {e}^{j φ ( t )} * p ( τ - {τ}_{b} ) + n ( τ , t ) \qquad [ Equation 4 ]$$

$${r}_{2} ( τ , t + Δ t ) = p ( τ ) + ρ {e}^{j φ ( t + Δ t )} * {e}^{j Δ ψ} * p ( τ - {τ}_{b} ) + n ( τ , t + Δ t )$$

Here, due to the movement of the target, φ(t+Δt) and φ(t) are not the same, and thus Δψ may not be measured and the AOA of the target may not be measured. When a movement of the target is not acquired within one frame and needs to be acquired through multiple frames, the electronic device 510 may transmit the number of packets corresponding to the FFT size (for example, twice the FFT size), and may determine the movement and frequency of the target. In this process, based on the movement cycle of the target, the FFT size may vary.

Here, when the common phase difference as shown in Equation 5 is applied to a plurality of signals r₁(τ, t) and a plurality of signals r₂(τ, t+Δt) transmitted and received corresponding to the FFT size, the movement of the target is offset and the phase difference Δψ may be determined.

$$arg \{ {\sum }_{t} {r}_{2} ( {τ}_{b} , t + Δ t ) * {{r}_{1} ( {τ}_{b} , t )}^{*} \} \approx E [ φ ( t + Δ t ) + Δψ ] - E [ φ ( t ) ] = Δψ \qquad [ Equation 5 ]$$

Specifically, in the process of calculating the common phase difference as shown in Equation 5, E[φ(t+Δt)+Δψ] and E[φ(t)] may be derived through the average of operations between a plurality of r₂(τ_{b}, t+Δt) and a plurality of r₁(τ_{b}, t)*. Here, because

$$φ ( t ) = \frac{2 π}{λ} {m}_{b} sin ( 2 π {f}_{b} t )$$

in the process of transmitting and receiving packets in response to the FFT size, E[φ(t+Δt)] and E[φ(t)] become 0 in Equation 5, the phase difference Δψ may be determined.

Therefore, when a switching method, for example, as shown in FIGS. 3A to 3D is applied to prevent self-interference from occurring, even in situations where the target is moving, the phase difference between different antennas may be determined by sufficiently many packets being transmitted and received, and thus the AOA of the target may be measured.

However, when there is no movement of the target (in this regard, Δt=0), in Equation 4, φ(t+Δt) and φ(t) are the same, and thus because there is no self-interference, the AOA of the target may be measured by only two packets being transmitted and received.

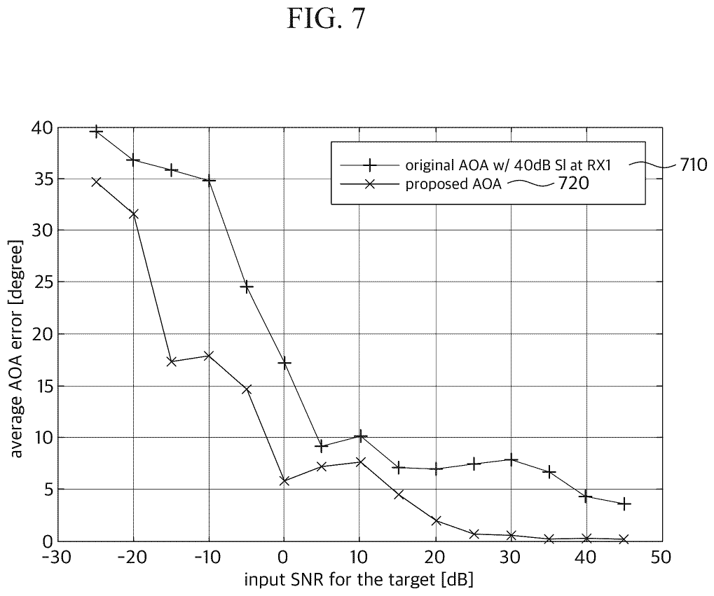

FIG. 7 is a diagram for explaining results of evaluating AOA measurement performance according to an example embodiment.

Referring to FIG. 7, a graph 710 illustrates performance related to AOAs measured in a situation where a transmitting terminal and a receiving terminal share an antenna, unlike the switch control illustrated in FIGS. 3A to 3D, and a graph 720 illustrates performance related to AOAs measured according to the switch control described with reference to FIGS. 3A to 3D. For reference, m_{b}=0.2 cm, dₒ=1.2 m, f_{b}=0.4 Hz, and the FFT size was set to 128 when the performance related to AOAs was measured. Here, the X-axis represents the input Signal to Noise Ratio (SNR) for the target, and the Y-axis represents the average AOA error.

Here, it may be identified that the AOA measurement performance of the graph 710 is worse than the performance of the graph 720 measured when no self-interference occurs due to 40 dB of self-interference at one receiving terminal. For example, when the graph 710 and the graph 720 are compared, it is identified that when the average AOA error (the y-axis) is 5 degrees, the input SNR (the x-axis) relative to the target varies by about 25 dB.

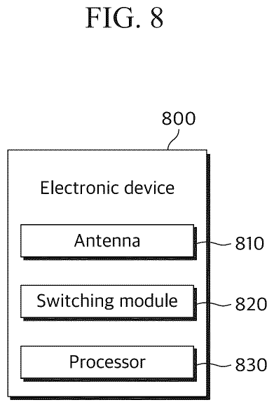

FIG. 8 is a block diagram for explaining an electronic device according to an example embodiment.

Referring to FIG. 8, an electronic device 800 may include an antenna 810, a switching module 820 and a processor 830. Those skilled in the art would understand that other elements can be included in addition to the elements illustrated in FIG. 8. Contents with respect to the electronic device 800 may include the above descriptions related to the electronic device, and thus the descriptions may be applied to the electronic device 800.

According to an example embodiment, the antenna 810 may include at least a first antenna and a second antenna, and the switching module 820 may include at least a first switch, a second switch and a third switch. The processor 830 may control the switching module 820 based on the control signal to receive the first signal transmitted through the first antenna at the first time through the second antenna, may control the switching module 820 based on the control signal to receive the second signal transmitted through the second antenna at the second time through the first antenna, and may control to identify the AOA of the target measured based on the first signal received through the second antenna and the second signal received through the first antenna.

Here, the first switch is a switch that selectively connects the first antenna terminal corresponding to the first antenna and the first receiving terminal, the second switch is a switch that selectively connects the second antenna terminal corresponding to the second antenna and the second receiving terminal, and the third switch is a switch that selectively connects either the first antenna terminal or the second antenna terminal to the transmitting terminal. Here, when a signal is transmitted through the second antenna and received through the first antenna to prevent self-interference, signals identified from each antenna may be distinguished from each other, for example, in terms of power. Similarly, even when a signal is transmitted through the first antenna and a signal is received through the second antenna, the signals identified from each antenna may be distinguished from each other in terms of power.

The processor 830 may control the AOA corresponding to a target to be identified based on the phase difference between the first signal received at the first time and the second signal received at the second time.

Here, at the first time, the processor 830 may control the switching module 820 based on the control signal that controls the first switch connecting the first receiving terminal and first antenna terminal to be off, the third switch may be controlled to connect the transmitting terminal and the first antenna terminal and disconnect the transmitting terminal and the second antenna terminal, and the second switch connecting the second receiving terminal and the second antenna terminal to be on. Further, at the second time, the processor 830 may control the switching module 820 based on the control signal that controls the first switch connecting the first receiving terminal and the first antenna terminal to be on, control the third switch to connect the transmitting terminal and the second antenna terminal and disconnect the transmitting terminal and the first antenna terminal, and control the second switch connecting the second receiving terminal and the second antenna terminal to be off.

In an example embodiment, when the target moves, the processor 830 may the determine the FFT size based on the moving cycle of the target, and control the number of first signals and second signals transmitted and received according to the determined FFT size. Here, the processor 830 may control the AOA of the target to be identified by applying the common phase difference to a plurality of first signals and a plurality of second signals transmitted and received in response to the FFT size.

In an example embodiment, when there is no movement of the target, the processor 830 may control the AOA corresponding to the target to be identified based on the first signal received at the first time and the second signal received at the second time. In this regard, unlike when there is movement of the target, when there is no movement of the target, the AOA of the target may be measured based on two different signals.

Further, the processor 830 may control a location of the target to be identified based on the AOA of the target. In this regard, the processor 830 may measure an AOA of the target, and identify location information of the target based on the AOA.

According to an example embodiment, the antenna 810 may include at least a first antenna and a second antenna, and the switching module 820 may include at least one switch by which the connection state with the antenna 810 including a first antenna and a second antenna is controlled. The processor 830 may control the switching module 820 based on the control signal in order to ensure that each antenna used when signals are transmitted and received at the first time and each antenna used when signals are transmitted and received at the second time are different, between the first antenna and the second antenna, and the processor 830 may control to identify the AOA of the target that is measured based on the signals received at the first time and the second time. The above described example embodiments may also be applied to the processor 830.

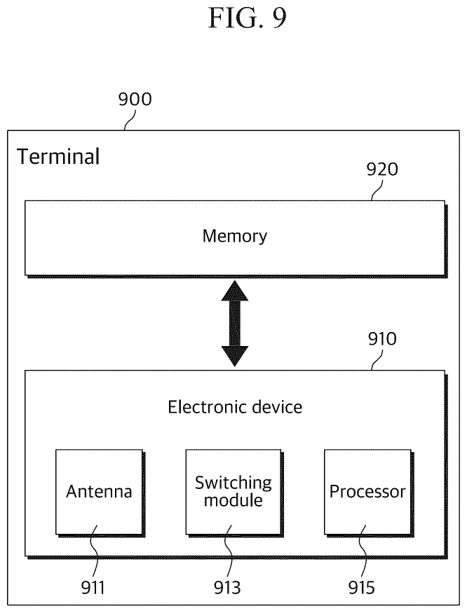

FIG. 9 is a block diagram for explaining a terminal according to an example embodiment.

Referring to FIG. 9, a terminal 900 may include an electronic device 910 and a memory 920. Those skilled in the art may understand that the terminal 900 may further include other elements in addition to the elements illustrated in FIG. 9.

The electronic device 910 may include at least one of an antenna 911, a switching module 913 and a processor 915. Above descriptions related to the electronic device may be applied to the electronic device 910 included in the terminal 900, and thus descriptions overlapping the above descriptions are omitted.

The processor 915 may control the overall operation of the electronic device 910 and process data and signals. In this regard, the processor 915 may control the overall operation of the electronic device 910 and process data and signals by executing instructions stored in the memory 920. The memory 920 may be distinguished from the electronic device 910 as illustrated in FIG. 9. Alternatively, the memory 920 may be built into the electronic device 910 unlike what is illustrated in FIG. 9.

According to an example embodiment, the terminal 900 may be implemented as a computer or portable terminal that may connect to a server or other terminal through a network. Here, computers may include, for example, laptops, desktops, laptops and so on equipped with a web browser, and portable terminals may include all types of handheld communication devices, such as communication-based terminals that ensure portability and mobility, smartphones and tablet computers.

The electronic device or the terminal according to the above-described example embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

In some example embodiments, each of the components represented by a block as illustrated in FIGS. 3A, 3B, 3C, 8 and 9 may be implemented as various numbers of hardware and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of example embodiments have been particularly shown and described, it will be understood that various changes in form and details may be made therein without departing from the spirit and scope of the following claims.

What is claimed is:

1. A method of operating an electronic device, the method comprising:
controlling a switching circuit to control a first signal transmitted through a first antenna at a first time to be received via a second antenna;
controlling the switching circuit to control a second signal transmitted via the second antenna at a second time to be received via the first antenna; and
identifying an angle of arrival (AOA) of a target based on the first signal received via the second antenna and the second signal received via the first antenna.

2. The method of claim 1, wherein the switching circuit comprises a first switch, a second switch and a third switch,
wherein the first switch selectively connects a first antenna terminal corresponding to the first antenna and a first receiving terminal,
wherein the second switch selectively connects a second antenna terminal corresponding to the second antenna and a second receiving terminal, and
wherein the third switch selectively connects a transmitting terminal to either the first antenna terminal or the second antenna terminal.

3. The method of claim 2, wherein controlling the switching circuit comprises, at the first time:
the first switch to disconnect the first receiving terminal and the first antenna terminal;
the third switch connecting to connect the transmitting terminal and the first antenna terminal; and
the second switch to connect the second receiving terminal and the second antenna terminal.

4. The method of claim 2, wherein controlling the switching circuit comprises, at the second time:
the first switch to connect the first receiving terminal and the first antenna terminal;
the third switch to connect connecting the transmitting terminal and the second antenna terminal; and
the second switch to disconnect the second receiving terminal and the second antenna terminal.

5. The method of claim 1, wherein the identifying the AOA of the target comprises identifying a phase difference between the first signal received at the first time and the second signal received at the second time.

6. The method of claim 5, wherein the identifying the AOA of the target comprises controlling the first signal and the second signal to be repeatedly transmitted and received according to a fast Fourier transform (FFT) size that is determined based on a cycle of movement of the target.

7. The method of claim 6, wherein the identifying the AOA of the target comprises applying a common phase difference between a plurality of first signals and a plurality of second signals transmitted and received according to the FFT size.

8. The method of claim 5, wherein the identifying the AOA of the target comprises identifying the AOA of the target based on the first signal received at the first time and the second signal received at the second time while the target is stationary.

9. The method of claim 1, further comprising identifying a location of the target based on the AOA of the target.

10. A non-transitory computer-readable recording medium storing a program for executing the method of claim 1 on a computer.

11. An electronic device comprising:
a plurality of antennas comprising a first antenna and a second antenna;
a switching circuit comprising a first switch, a second switch and a third switch; and
a processor configured to:
control the switching circuit to receive, via the second antenna, a first signal transmitted via the first antenna at a first time,
control the switching circuit to receive, via the first antenna, a second signal transmitted via the second antenna at a second time, and
identify an angle of arrival (AOA) of a target based on the first signal received via the second antenna and the second signal received via the first antenna.

12. The electronic device of claim 11, wherein the first switch is configured to selectively connect a first antenna terminal corresponding to the first antenna and a first receiving terminal,
wherein the second switch is configured to selectively connect a second antenna terminal corresponding to the second antenna and a second receiving terminal, and
wherein the third switch is configured to selectively connect a transmitting terminal to either the first antenna terminal or the second antenna terminal.

13. The electronic device of claim 11, wherein the processor is further configured to identify the AOA of the target based on a phase difference between the first signal received at the first time and the second signal received at the second time.

14. The electronic device of claim 12, wherein the processor is further configured to control, at the first time:
the first switch to disconnect the first receiving terminal and the first antenna terminal;
the third switch to connect the transmitting terminal and the first antenna terminal; and
the second switch to connect the second receiving terminal and the second antenna terminal.

15. The electronic device of claim 12, wherein the processor is further configured to control, at the second time:
the first switch to connect the first receiving terminal and the first antenna terminal;
the third switch to connect the transmitting terminal and the second antenna terminal; and
the second switch to disconnect the second receiving terminal and the second antenna terminal.

16. The electronic device of claim 13, wherein the processor is further configured to control the first signal and the second signal to be repeatedly transmitted and received according to a fast Fourier transform (FFT) size that is determined based on a cycle of movement of the target.

17. The electronic device of claim 16, wherein the processor is further configured to identify the AOA of the target by applying a common phase difference between a plurality of first signals and a plurality of second signals transmitted and received according to the FFT size.

18. The electronic device of claim 13, wherein the processor is further configured to identify the AOA of the target based on the first signal received at the first time and the second signal received at the second time while the target is stationary.

19. The electronic device of claim 11, wherein the processor is further configured to identify a location of the target based on the AOA of the target.

20. An electronic device comprising:
a plurality of antennas comprising a first antenna and a second antenna;
a switch circuit comprising a plurality of switches configured to control connection states of the plurality of antennas; and
a processor configured to control the switch circuit to control the connection states at a first time to be different than the connection states at a second time, and identify an angle of arrival (AOA) of a target based on the signals received at the first time and the second time.
